(19) United States
(12) Patent Application Publication
(10) Pub. No.: US 2015/0248129 A1
(43) Pub. Date: Sep. 3, 2015

(54) SAMPLE-KEYED ADAPTIVE PRODUCT DEVELOPMENT TOOL

(71) Applicant: Bank of America Corporation, Charlotte, NC (US)

(72) Inventors: Sushmita Roy, JR., New Delhi (IN); Nitin Bhatt, Uttarakhand (IN)

(73) Assignee: Bank of America Corporation, Charlotte, NC (US)

(21) Appl. No.: 14/195,008

(22) Filed: Mar. 3, 2014

(51) Int. Cl. G05B 19/418

(52) U.S. Cl. CPC G05B 19/4188; G05B 2219/32084

(57) ABSTRACT

Apparatus, methods, media and code for a product development tool. The tool may control a processor. The processor may be configured to determine that a first set of performance metrics does not satisfy a threshold analysis criterion. The performance metrics may correspond to a deployed product and a user segment. A user segment may be a set of individuals that use a product or service. The segment may be a sample of a population of users. An institution may provide the product to one or more of the customers to provide the customer with an opportunity to acquire or use additional measures of goods that the customer already has or uses.

### FIELD OF TECHNOLOGY

This application relates to product development. More specifically, the application relates to tools for product development.

### BACKGROUND OF THE INVENTION

A provider of goods and services (the “goods”) to customers in a marketplace often provides to the customers to stimulate use of the goods and to provide new goods to existing and new customers. Increased use of the goods and the acquisition of new goods by existing and new customers may increase the provider's revenue.

It would therefore be desirable to provide apparatus, methods, articles of manufacture including computer readable code, and media for developing the products.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative apparatus in accordance with the principles of the invention;

FIG. 2 shows illustrative apparatus in accordance with the principles of the invention;

FIG. 3 shows a configuration of illustrative apparatus in accordance with the principles of the invention;

FIG. 4 shows illustrative steps of a process in accordance with the principles of the invention;

FIG. 5 shows illustrative steps of a process in accordance with the principles of the invention;

FIG. 6 shows a configuration of illustrative apparatus in accordance with the principles of the invention; and

FIG. 7 shows a configuration of illustrative apparatus in accordance with the principles of the invention.

### DETAILED DESCRIPTION OF THE INVENTION

Apparatus, methods, articles of manufacture including computer readable code, and media for development of a product are provided. The apparatus may include, the methods may involve, and the media may control a processor. The processor may be configured to determine that a first set of performance metrics does not satisfy a threshold analysis criterion. The performance metrics may correspond to a deployed product and a user segment.

A user segment may be a set of individuals that use a product or service. The segment may be a sample of a population of users. A user in the segment may be an individual. The deployed product may be a product or service that is provided to the individuals. The deployed product may be a product or service that is offered to the individuals. The deployed product may be a product or service that is used by the individuals. The individuals may be members of a population of customers. The customers may be customers of an entity. The entity may be a financial institution. A customer may use a credit card that the institution issued to the customer. The institution may provide one or more of a financial service, apparatus, transaction instrument or information (such as a transaction card, PIN or other suitable instrument or information), account or other suitable goods and services (the “goods”) to the customer. The institution may provide the product to one or more of the customers to provide the customer with an opportunity to acquire or use new goods. The institution may provide the product to one or more of the customers to provide the customer with an opportunity to acquire or use additional measures of goods that the customer already has or uses.

Table 1 shows illustrative user segments. User segments may be defined within a marketing framework. User segments may be defined within a risk framework. User segments may be defined within any other suitable framework. Within a framework, user segments may be categorized as being at different levels. A lower level segment may include a higher level segment.

TABLE 1
Illustrative user segments.

| | Illustrative User Segments | |
|---|---|---|
| Level | Marketing | Risk |
| 1 | Customers who shopped in | Customers who were given a credit |
| | the last 6 months with a | line increase in last 6 months |
| | store | |
| 2 | Customers who shopped for | Customers who were given a credit |
| | >$1000 in last 6 months in a | line increase in last 6 months of |
| | store | by more than 10% of existing |
| | | credit line |
| 3 | Customer who shopped in | Customers who were given a credit |
| | food products for value | line increase in last 6 months of |
| | >$1000 in last 6 months | by more than 10% of existing |
| | | credit line and had a FICO rating |
| | | of 730+ |

Table 2 shows illustrative performance metrics. Performance metrics may be defined within a marketing framework. Performance metrics may be defined within a risk framework. Performance metrics may be defined within any other suitable framework.

TABLE 1
Illustrative performance metrics.
Illustrative Performance Metrics

| Marketing | Risk |
|---|---|
| Activation Rate | Activation rate |
| (proportion) | (proportion) |
| Payment Rate | Loss rate |
| (proportion) | (proportion) |
| Rollover Rate | Payment rate |
| (proportion) | (proportion) |
| Average Retail Spend | Average utilization |
| (mean) | (mean) |
| Average Cash Spend | Average retail spend |
| (mean) | |
| Average balances | Average cash spend |
| (mean) | |

When the institution provides a product to the user, the institution may test the performance of the product. The test may include detecting a change in behavior of a population of the users. The behavior may be characterized by a performance metric. The users may be categorized into different user segments. The apparatus, methods, articles of manufacture including computer readable code, and media may select one or more of the user segments as a specimen for testing one or more of the performance metrics. The performance metric may be characterized before the product is offered. This performance metric may be a “reference” performance metric. The reference performance metric may correspond to a control group. The performance metric may be characterized at a time after the product is offered.

The performance metric may correspond to a test group. The control group may include individuals that are not in the test group. The test group may include individuals that are not in the control group.

The different individuals of the control and test groups may correspond to the same user segment. The different individuals of the control and test groups may correspond to different user segments.

A difference between the performance metric after the product is offered and the performance metric before the product is offered may be statistically significant. The difference may include a difference between performance metrics of a control group and performance metrics of a test group. The difference may include a difference between performance metrics for a group of individuals at a reference time and performance metrics for the group at a test time. the test time may be later than the reference time.

A control group may be monitored over time. The difference may be a first difference. The first difference may include a difference between performance metrics of a control group and performance metrics of a test group at a reference time. A second difference may include a difference in performance metrics of the control group at a reference time and performance metrics of the test group at a test time.

A hypothesis that the difference not significant may be referred to as a “null” hypothesis. The apparatus, methods, articles of manufacture including computer readable code, and media may test whether the selected segment or segments include a sufficient number of users to yield a statistically significant difference between the performance metrics at the different times.

The performance metric may correspond to a test group. The control group and the test group may include different individuals. The different individuals may correspond to the same user segment. The different individuals may correspond to different user segments. A difference between the performance metric after the product is offered and the performance metric before the product is offered may be statistically significant. The difference may correspond to a difference between performance metrics of a control group and performance metrics of a test group. The difference may correspond to performance metrics for a group of individuals that are monitored at a reference time and then later at a test time. A control group may be monitored over time. The difference may be a first difference. The first difference may correspond to a control group and a test group at a reference time. A second difference may correspond to the control group and the test group, at a “test” time. A hypothesis that the difference not significant may be referred to as a “null” hypothesis. The apparatus, methods, articles of manufacture including computer readable code, and media may test whether the selected segment or segments include a sufficient number of users to yield a statistically significant difference between the performance metrics at the different times.

Significance may be based on statistical significance testing. Such testing may be used to compare two independent and mutually exclusive samples, such as sets of performance metrics, corresponding to different times or conditions, from a population of customers to check whether a difference between the sets is significant at a certain level of confidence.

T-test for difference in means. The unpaired or ‘independent samples’ t-test may be used when two separate sets of samples are obtained, one from each of the populations under comparison. The two samples may be independent. The two samples may be identically distributed. The two samples may be similarly distributed. The two samples may be arbitrarily distributed. A t-test may be used to for a difference in means and can be either unpaired or paired.

Test for proportions (Z-test): The Z-test may be used to compare proportions (e.g., fraction of population that accepted an offer) from two groups. The groups may be independent groups (i.e., with no overlap between them such as a test population of customers and a control population of customers) to determine if the are significantly different from one another. The test may be used to compare two proportions created by two samples of a population or two subgroups of one sample. One or more of the samples may be a random sample.

Equation 1 shows an illustrative definition of lower and upper values of a confidence interval for a performance metric that is expressed as a proportion (For example, activation rate of a credit card offer)

$$( \hat{p} - 1.96 \sqrt{\frac{\hat{p} ( 1 - \hat{p} )}{n}} , \hat{p} + 1.96 \sqrt{\frac{\hat{p} ( 1 - \hat{p} )}{n}} ) \qquad Eqn . 1$$

\hat{p} is a sample average. \hat{p} may be a performance metric for a user segment. For example, \hat{p} may be the average acceptance of an offer. The offer may be included in a marketing campaign. Success (acceptance) of the offer may be valued as 1. Failure (rejection) of the offer may be valued as 0. Equation 2 shows an illustrative formula for evaluation \hat{p} for the user segment.

$$\hat{p} = \frac{{\sum }_{n = 1}^{N} {p}_{n}}{N} \qquad Eqn . 2$$

pₙ is the success or failure value (1 or 0) for the nth individual of the N individuals in the selected segment.

Equation 3 shows an illustrative definition of lower and upper values of a confidence interval for a performance metric that is expressed as a mean (For example, mean spend (in dollars, e.g.) using an active card)

$$( \overline{X} - 1.96 \frac{σ}{\sqrt{N}} , \overline{X} + 1.96 \frac{σ}{\sqrt{N}} , ) \qquad Eqn . 3$$

X̅ is the mean value of the performance metric for the N individuals in the user segment. σ is standard deviation of the performance metric for the user segment.

The apparatus, methods, articles of manufacture including computer readable code, and media may compute an incremental return-on-investment (“IROI”) corresponding to the outcome of providing the product. The IROI may correspond to a marketing campaign. The IROI may indicate the success of the marketing campaign. The IROI may indicate the monetary value of the marketing campaign. The IROI may be based on the reference performance metric. This may be referred to as the “baseline” or “control.” A performance metric may be referred to as a “driver.” Upper and lower limits for drivers may be assigned for quality control to make sure that observed driver values are within allowed tolerance ranges.

When IROI is greater than zero, the product outcome may be referred to as “lift.” When IROI is less than zero, the product outcome may be referred to as “suppression.” If lift or suppression is statistically significant, the lift or suppression may be applied to reference performance metrics to predict future values of performance metrics.

One or more of lift, suppression, IROI, return-on-investment, performance metrics and segments, or projections of one or more of the foregoing, may be used to select among or design products for future offering to customers or prospective customers and thus may be included in a product development process.

The user segment may be a first user segment. The processor may be configured to determine that a second set of performance metrics does satisfy the threshold analysis criterion. The second set of performance metrics may correspond to the deployed product and to a second user segment. The second user segment may include the first user segment.

The product may include an apparatus. The product may include information. The product may include a financial product. The product may include an offer for a financial product. The product may include money. The product may include a credit line increase or decrease. The product may include an improved product launch relative to an existing product. The product may include a new or improved strategy relative to an existing strategy. The product may include an offer for money. The product may include an offering under a marketing campaign. The marketing campaign may be directed toward the customers.

The apparatus, methods, articles of manufacture including computer readable code, and the media may control an input device. The input device may be configured to receive from a user a selection of a performance metric type. The input device may be configured to receive from a user a selection of a process control flag.

The apparatus may include, the methods may involve, and the media may control machine-readable memory. The machine-readable memory may be configured to store a first value of a first objective function corresponding to a first weight of the product. The machine-readable memory may be configured to store a second value of a second objective function corresponding to a second weight of the product. The machine-readable memory may be configured to store a reference set of performance metrics corresponding to the product.

The apparatus may include, the methods may involve, and the media may control an output device. The output device may be configured to indicate the second weight. The output device may be configured to indicate that a score of the difference between the second set of performance metrics and the reference set of performance metrics exceeds a predetermined value.

The threshold analysis criterion may be a power test criterion. The power test criterion may be included in a power analysis tool.

Power analysis yield a minimum effect-size that is likely to be detected in a study using a given sample size. Power analysis may be used to make comparisons between different statistical testing procedures: for example, between a parametric and a nonparametric test of the same hypothesis.

The power of a hypothesis test may be affected by three factors:

Sample size. For example, a greater sample size may result in a greater power of the test.

Significance level. For example, a higher significance level may correspond to a higher power of the test. If significance level is increased, a region of acceptance of the hypothesis may be reduced. As a result, rejection of the null hypothesis is more likely. Rejection of the null hypothesis makes it less likely that the null hypothesis will be accepted when the null hypothesis is false; i.e., likelihood of a Type II error is reduced. Hence, the power of the test is increased.

The “true” value of the parameter, such as an average value of a performance metric, being tested. The greater the difference between the “true” value of a parameter and the value specified in the null hypothesis, the greater the power of the test. That is, the greater the effect-size, the greater the power of the test.

The power test criterion may be satisfied by inclusion in the second set of performance metrics a number of members. A relatively larger number of members may lead to the power test criterion being satisfied. A relatively smaller number of members may lead to the power test criterion not being satisfied.

The input device may be configured to receive a confidence level index. The confidence level index may correspond to the difference between the second set of performance characteristics and the reference set of characteristics. The confidence level index may include a selected confidence level.

The input device may be configured to receive change a value of the power test criterion based on the confidence level index.

The input device may be configured to receive a target change index that corresponds to the difference between the second set of performance characteristics and the reference set of characteristics. The target change may be a selected change between a mean of the reference set of performance characteristics and a mean of the second set of performance characteristics.

The input device may be configured to change a value of the power test criterion based on the target change index.

The machine readable memory may be configured to store the first user segment. The machine readable memory may be configured to store the second user segment. The first and second user segments may be included in a plurality of user segments. All but a one of the plurality of user segments may be included in another of the user segments in the plurality.

The plurality of user segments may be a first plurality. The second user segment may include a second plurality of user segments. The second plurality may include the first user segment. The processor may be configured to identify individual users corresponding to the second plurality of user segments. The processor may be configured to identify the individual users that belong to the second user segment.

The processor may be configured to detect that the performance metric type is a proportion. The processor may be configured to, in response to detecting that the performance metric type is a proportion, compute a confidence interval for the second set of performance metrics. The processor may be configured to detect that the performance metric type is a proportion. The processor may be configured to, in response to detecting that the performance metric type is a proportion, compute a confidence interval for the second set of performance metrics.

The second set of performance metrics may be represented by a second mean. The reference set of performance metrics may be represented by a reference mean. The difference may include a difference between the second mean and the reference mean. The processor may be configured to calculate a confidence interval corresponding to the difference. The second set of performance metrics may be represented by a second proportion. The reference set of performance metrics may be represented by a reference proportion. The difference may include a difference between the second proportion and the reference proportion. The processor may be configured to calculate a confidence interval corresponding to the difference.

The processor may be configured to evaluate the control flag as one of a one-tail test flag and a two-tail test flag or as any other suitable test flag.

The processor may be configured to calculate a product development score that includes: if the score exceeds the predetermined value, the quantity:

$$\frac{\{ \begin{matrix}E ( second set of performance metrics ) - \\ E ( reference set of performance metrics )\end{matrix} \}}{E ( reference set of performance metrics )} ,$$

in which E means expected value; and, if the score does not exceed the predetermined value, only the quantity zero. The output device may be configured to display the score.

The processor may be configured to calculate a product development score that includes: if the score exceeds the predetermined value, the quantity:

$$\frac{{\hat{p}}_{second} - {\hat{p}}_{preference}}{{\hat{p}}_{preference}} ,$$

in which β means average number of user successes for a respective set of performance metrics, the average number being the total number of successes divided by the total number of corresponding users; and, if the score does not exceed the predetermined value, only the quantity zero. The output device may be configured to display the score.

The processor may be configured to calculate a product development score that includes: if the score exceeds the predetermined value, the quantity:

$$\frac{{\hat{p}}_{second} - {\hat{p}}_{preference}}{{\hat{p}}_{preference}} ,$$

in which β means average number of user successes for a respective set of performance metrics, the average number being the total number of successes divided by the total number of corresponding users; and, if the score does not exceed the predetermined value, the quantity zero or an index corresponding to an insignificant difference between the sets of performance metrics. The output device may be configured to display the score.

The score may be a z-statistic.

The apparatus, methods, articles of manufacture including computer readable code, and media may involve the use of an analytical platform such as that available under the trademark SAS from SAS Institute Inc. (Cary, N.C.).

SAS software is readily available. The tool may incorporate modules of the SAS software. The tool may exchange information with a SAS module. The tool may reference information that is referenced by the SAS software. The analytical platform may be used to perform one or more tests of one or more performance metric sets. The analytical platform may be used to perform one or more comparisons between two or more performance metric sets. The apparatus, methods, articles of manufacture including computer readable code, and media may involve the use of a processing platform such as that available under the trademark Excel from Microsoft (Redmond, Wash.). The processing platform may be used to group (or “roll up”) user segments, select user segments for analysis, select performance metrics, receive analyst input, and display results to an analyst.

Illustrative embodiments of the apparatus, methods, articles of manufacture including computer readable code, and media in accordance with the principles of the invention will now be described with reference to the accompanying drawings, which form a part hereof. It is to be understood that other embodiments may be utilized and structural, functional and procedural modifications may be made without departing from the scope and spirit of the present invention.

One of ordinary skill in the art will appreciate that the elements shown and described herein may be performed in other than the recited order and that one or more elements illustrated may be optional. The methods of the above-referenced embodiments may involve the use of any suitable elements, elements, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

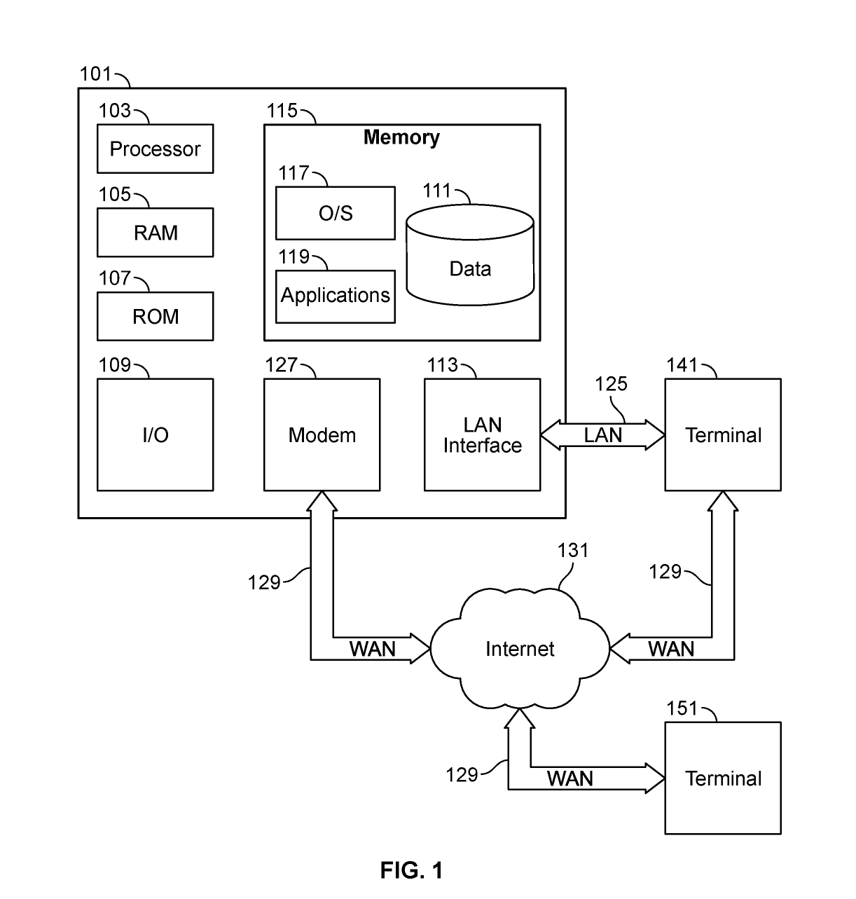

Processes in accordance with the principles of the invention may include one or more features of the processes illustrated in the FIGS. For the sake of illustration, the steps of the illustrated processes will be described as being performed by a “system.” The “system” may include one or more of the features of the apparatus that are shown in FIGS. 1-3 and 6-7 and/or any other suitable device or approach. The “system” may be provided by the organization, another party or any other suitable party.

FIG. 1 is a block diagram that shows illustrative computing device 101, which may be specifically configured as a component in one or more of the devices shown in FIG. 1. For example, a computing device such as 101 may be present in a tool for product development.

Computing device 101 may be included in any suitable apparatus that is shown or described herein. Computing device 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling computing device 101 to perform various functions. For example, memory 125 may store software used by computing device 101, such as an operating system 117, application programs 119, and an associated database 121. Alternatively, some or all of computing device 101 computer executable instructions may be embodied in hardware or firmware (not shown).

Computing device 101 may operate in a networked environment supporting connections to one or more remote computers, such as terminals 141 and 151. Terminals 141 and 151 may be personal computers or servers that include many or all of the elements described above relative to computing device 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, computing device 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by computing device 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, Blackberry™, or any other suitable device for storing, transmitting and/or transporting relevant information.

Any information described above in connection with database 121, and any other suitable information, may be stored in memory 125.

One or more of applications 119 may include one or more algorithms that may be used to execute instructions for performing a power test, calculate a proportion, calculate a mean, calculate a standard deviation, calculate a standard error, calculate a Z-statistic, calculate a confidence interval, check a range tolerance, receive digital input information, display output information, and/or perform any other suitable tasks related to a tool for product development.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

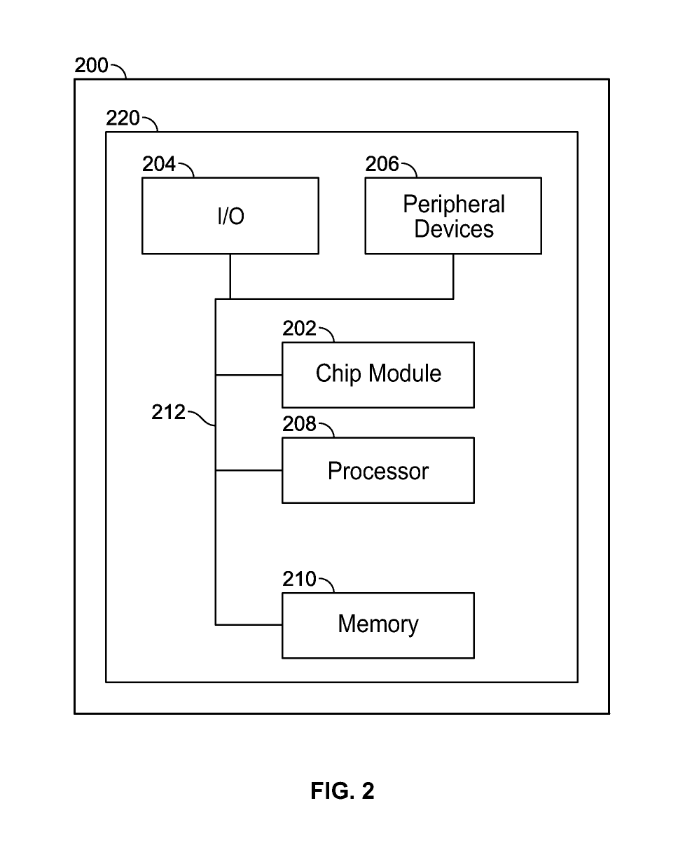

FIG. 2 shows illustrative apparatus 200. Apparatus 200 may have one or more features in common with apparatus shown in FIG. 1. Apparatus 200 may be a computing machine. Apparatus 200 may include chip module 202, which may include one or more integrated circuits, and which may include logic configured to execute instructions for performing a power test, calculate a proportion, calculate a mean, calculate a standard deviation, calculate a standard error, calculate a Z-statistic, calculate a confidence interval, check a range tolerance, receive digital input information, display output information, and/or perform any other suitable tasks related to a tool for product development.

Apparatus 200 may include one or more of the following components: I/O circuitry 204, which may include the transmitter device and the receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may execute instructions for performing a power test, calculate a proportion, calculate a mean, calculate a standard deviation, calculate a standard error, calculate a Z-statistic, calculate a confidence interval, check a range tolerance, receive digital input information, display output information, and/or perform any other suitable tasks related to a tool for product development and exchange information with machine-readable memory 210.

Machine-readable memory 210 may be configured to store in machine-readable data-structures that represent user segments, performance metrics, instructions for performing a power test, calculate a proportion, calculate a mean, calculate a standard deviation, calculate a standard error, calculate a Z-statistic, calculate a confidence interval, check a range tolerance, receive digital input information, display output information, and/or perform any other suitable tasks related to a tool for product development; and any other suitable information or data.

Components 202, 204, 206, 208 and 210 may be coupled together by a system bus or other interconnections 212 and may be present on one or more circuit boards such as 220. In some embodiments, the components may be integrated into a single silicon-based chip.

It will be appreciated that software components including programs and data may, if desired, be implemented in ROM (read only memory) form, including CD-ROMs, EPROMs and EEPROMs, or may be stored in any other suitable computer-readable medium such as but not limited to discs of various kinds, cards of various kinds and RAMs. Components described herein as software may, alternatively and/or additionally, be implemented wholly or partly in hardware, if desired, using conventional techniques.

Various signals representing information described herein may be transferred between a source and a destination in the form of electromagnetic waves traveling through signal-conducting media such as metal wires, optical fibers, and/or wireless transmission media (e.g., air and/or space).

Apparatus 200 may operate in a networked environment supporting connections to one or more remote computers via a local area network (LAN), a wide area network (WAN), or other suitable networks. When used in a LAN networking environment, apparatus 200 may be connected to the LAN through a network interface or adapter in I/O circuitry 204. When used in a WAN networking environment, apparatus 200 may include a modem or other means for establishing communications over the WAN. It will be appreciated that the network connections shown are illustrative and other means of establishing a communications link between the computers may be used. The existence of any of various well-known protocols such as TCP/IP, Ethernet, FTP, HTTP and the like is presumed, and the system may be operated in a client-server configuration to permit a user to operate logical processing device 208, for example over the Internet.

Apparatus 200 may be included in numerous general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, tablets, programmable consumer electronics, network personal computers, minicomputers, mainframe computers, distributed computing environments that include any of the above systems or devices, and the like.

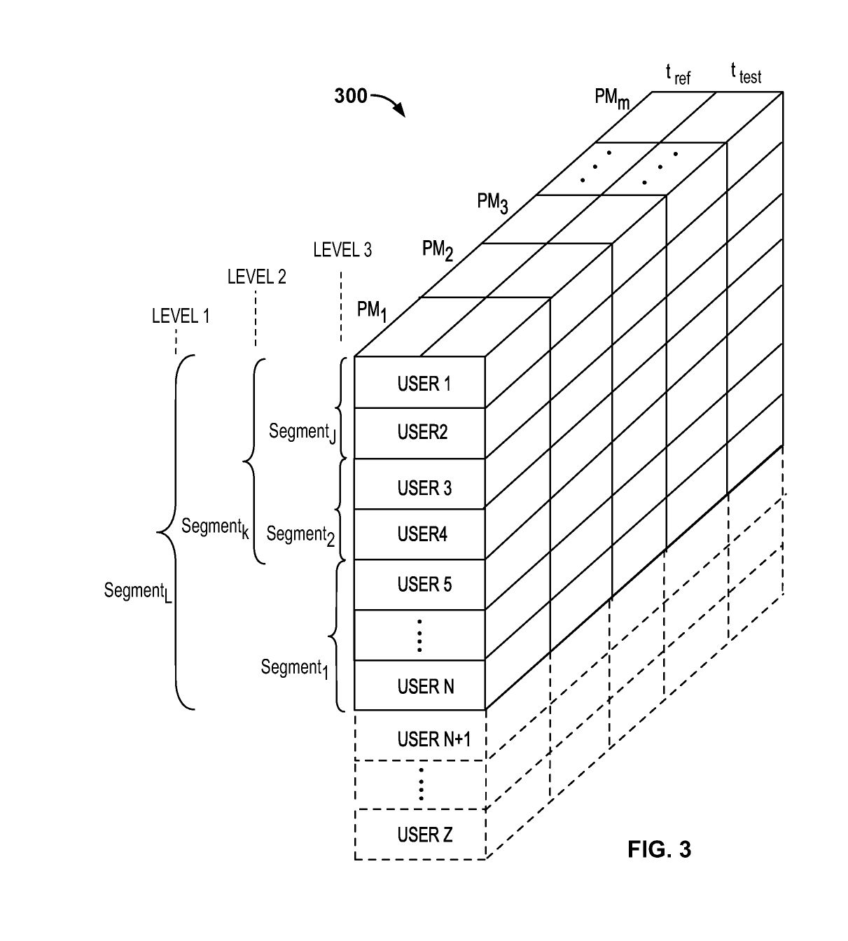

FIG. 3 shows illustrative machine readable memory map 300. Machine readable memory map 300 corresponds to machine readable memory that may be used to store performance metrics PM_{1 . . . M} for each of N users, User_{1 . . . N} in a population of users 1 . . . Z. Level 1 segment_{L} is a sample of the Z users that includes users 1 . . . N. Level 2 segment_{K} is included in segment_{L}. Level 3 segment 1 is included in segment L. Level 3 segments 2 and J are included in segment_{K}.

An analyst may obtain performance metrics PMm for users 1 to N. The analyst may select a segment or a segment of the users for analysis. Performance metrics PMm may be analyzed at time t_{ref}. Performance metrics PMm may be analyzed at time tₜₑₛₜ. Tₜₑₛₜ may be later tₜₑₛₜ. T_{ref} may refer to a set of conditions other than time. Tₜₑₛₜ may refer to a set of conditions other than time. The test conditions may be different from the reference conditions.

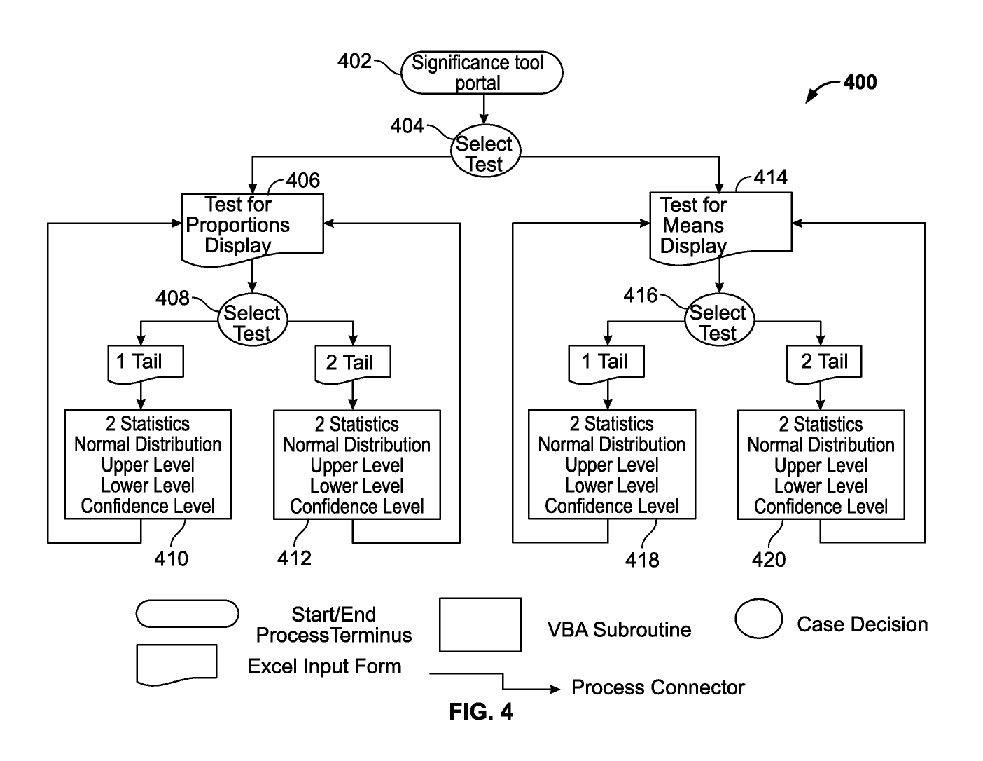

FIG. 4 shows illustrative process 400 that may be executed by the system. At step 402, a significance tool portal of the system may be activated. At step 404 an analyst may select a test for proportions or a test for means.

If at step 404, the analyst selects a test for proportions, process 400 may continue at step 406. At step 406, the system may display proportion test information to the analyst. At step 408, the analyst, in response to the information, may select a 1-tail or a 2-tail test. The test may compare a first value with a second value. The comparison may be based on whether or not the first value is greater than, less than, or equal to second value. The comparison may also be based on whether or not the first value is not equal to the second value.

If at step 408, the analyst selects a 1-tail test, process 400 may continue at step 410. At step 410, the analytical platform may perform one or more of: a Z test for difference between two proportions, a check of performance metric values against a predetermined lower limit, a check of performance metric values against a predetermined upper limit, an evaluation of a confidence level, or any other suitable calculation.

If at step 408, the analyst selects a 2-tail test, process 400 may continue at step 412. At step 412, the analytical platform may perform one or more of: a Z test for difference between two proportions, a check of performance metric values against a predetermined lower limit, a check of performance metric values against a predetermined upper limit, an evaluation of a confidence level, or any other suitable calculation.

If at step 404, the analyst selects a test for means, process 400 may continue at step 414. At step 414, the system may display proportion test information to the analyst. At step 416, the analyst, in response to the information, may select a 1-tail or a 2-tail test. The test may compare a first value with a second value. The comparison may be based on whether or not the first value is greater than, less than, or equal to second value. The comparison may also be based on whether or not the first value is not equal to the second value.

If at step 416, the analyst selects a 1-tail test, process 400 may continue at step 418. At step 418, the analytical platform may perform one or more of: a Z test for difference between two proportions, a check of performance metric values against a predetermined lower limit, a check of performance metric values against a predetermined upper limit, an evaluation of a confidence level, or any other suitable calculation.

If at step 408, the analyst selects a 2-tail test, process 400 may continue at step 420. At step 420, the analytical platform may perform one or more of: a Z test for difference between two proportions, a check of performance metric values against a predetermined lower limit, a check of performance metric values against a predetermined upper limit, an evaluation of a confidence level, or any other suitable calculation.

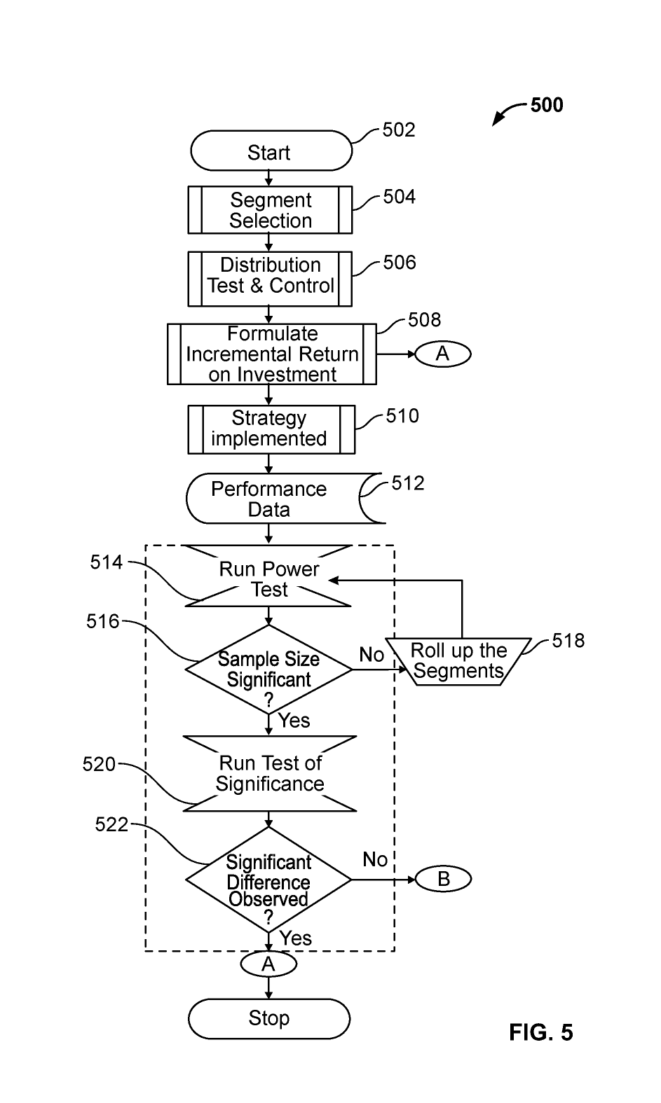

FIG. 5 shows illustrative process 500 that may be executed by the system. Process 500 may begin at step 502. At step 504, the system may receive from an analyst a selection of an initial user segment. For example, the system may receive a selection of segment2 (shown in FIG. 3). At step 506, the system may test the distribution of performance metrics of interest at tref for the selected segment. The distribution may be tested. At step 508, the system may formulate an IROI. Equation 4 shows an illustrative formulation of IROI.

$$\begin{matrix}IncrementalProfit / BusinessDevelopmentExpense ( IROI ) - ( {BaselineRevenue ( BR )}_{Control} + {IncrementalRevenue ( IR )}_{Test} ) - ( {BaselineCost ( BC )}_{Control} + IncrementalCost ( IC ) Strategy ) + / - BottomLineAdjustments ( BLA ) & Eqn . 4 \\ IncrementalRevenue = \{ \begin{matrix}BR * \{ \frac{\{ \begin{matrix}E ( second set of performance metrics ) - \\ E ( reference set of performance metrics )\end{matrix} \}}{E ( reference set of performance metrics )} \} & ( for means ) \\ BR * \{ \frac{{\hat{p}}_{second} - {\hat{p}}_{preference}}{{\hat{p}}_{preference}} \} & ( for porportions )\end{matrix} \} & Eqn . 5\end{matrix}$$

A user segment may be included in, or used as, a control group. The control group may include a customer who was eligible to receive the product, but was not provided with the product. The test group may include a customer who was part of the change or strategy i.e. a back to school marketing campaign, a credit line change, a change in call handling (VRU call handling instead of manual call handling). The revenue may include a selling price. The revenue may include a surcharge or fee. The revenue may include interest income, in a case where a credit card may be involved. The cost may include marketing costs. The cost may include fulfillment costs. The cost may include underwriting costs. The cost may also include agent incentives.

The return on investment may vary depending on one or more factors. The factors may include the product. The factors may include the industry. In order to derive the profit, one or more metrics may be used to arrive at one or more values which may be industry specific. The tool may compare each of these metrics to determine the incremental value. The incremental value may be 0 in a case in which the population values are not statistically different. The incremental value may be a percentage of the control or baseline value. For example, if without a marketing and/or credit line increase, the assumption would be that customers will spend an average of ten dollars, and because of the strategy customers will spend fifteen dollars, the incremental gain would be five dollars (150% of the control value, assuming that the two numbers are statistically different).

At step 510, the system or the institution may implement a strategy. Implementation of the strategy may include providing the product to users.

At step 512, performance data may be collected. At step 514, a power test may be performed to reduce the likelihood of false rejection of a difference between performance metrics at tref and ttest based on insufficient numbers of users. At step 516, the result of the power test may be evaluated.

If at step 516, the number of users is found to be too small, process 500 may continue at step 518. At step 518, the number of users in the analysis may be increased by “rolling up” segments. For example, machine readable memory 300 (shown in FIG. 3) may be used to roll up from segment 2, to segment K, which is at a lower level, and thus includes users from a segment or segments other than segment 2. In this example, segment K includes also segment J. Process 500 may then continue at step 514.

If at step 516, the number of users is found to be sufficient, process 500 may continue at step 520. At step 520, a test of significance may be performed to determine whether a difference between performance metrics at tref and ttest is significant at a particular confidence level. At step 522, the significance of the difference may be evaluated.

If at step 522 the difference is found to be significant, the system may output the IROI may be output

If at step 522 the difference is found to be not significant, the system may output the IROI as illustrated in Equation 6.

ROI=BR_{Control}−(BC_{Control}+IC_{Strategy})+/−BLA Eqn. 6

### Hypothetical Examples

The null hypothesis may be rejected when the absolute value of the Z-statistic, which may be referred to as a “score” is greater than a predetermined value. The predetermined value may be 1.96 or any other suitable value. Rejection of the null hypothesis may support the conclusion that the performance metric at ttest is different from the performance metric at tref. If the absolute value of the Z-statistic is less than the predetermined value, it may be concluded that the difference in performance metric may have risen by chance. For example, the Z-statistic may be found to be about 1.97245. The confidence level may be quantified as:

| 2-tail test (Z_{0.025}) | 1-tail test (Z_{0.005}) |
|---|---|
| 1.96 | 2.576 |

Because |Z|=1.97245>1.96, the null hypotheses would be rejected under the two-tail test.

The Excel function NORMSDIST (Z-val) may be used to obtain the value for a standard normal distribution. This will determine a probability such as Pr(X<=1.97245) based on a cumulative distribution function, i.e., the area under the standard normal curve. This implies that 97.5% of the population lies between −1.97245 and 1.97245 standard deviation from the mean. An acceptable maximum error rate is 2.5%, which implies a confidence level regarding the existence of a difference between the performance metrics at t_{ref} and tₜₑₛₜ.

Examples follow the following format:

| | | | | Segment i at | | Segment i at | | | |
|---|---|---|---|---|---|---|---|---|---|
| Segment i | | Segment i | | t_{ref} | | tₜₑₛₜ | | | |
| at t_{ref} | | at tₜₑₛₜ | | Upper | Lower | Upper | Lower | | Conf. |
| N | \hat{p} | N | \hat{p} | Limit | Limit | Limit | Limit | Z-Stat | Level |
| 108 | 23.10% | 123 | 13.10% | 31.05% | 15.15% | 19.06% | 7.14% | 1.9724 | 97.57% |

The performance metric may be user spend rate or number of spends per account. The null hypothesis may be rejected based on the Z statistic and Confidence level. IROI may be calculated as in Equation 4. The upper and lower limits may be used to flag values outside of the expected range that may have substantial impact on calculated values of IROI.

### Example 1

Sample size significance not observed and statistical difference not observed.

| | | | | Segment i at | | Segment i at | | | |
|---|---|---|---|---|---|---|---|---|---|
| Segment i | | Segment i | | t_{ref} | | tₜₑₛₜ | | | |
| at t_{ref} | | at tₜₑₛₜ | | Upper | Lower | Upper | Lower | | Conf. |
| N | \hat{ p} | N | \hat{p} | Limit | Limit | Limit | Limit | Z-Stat | Level |
| 180 | 88.24% | 61 | 79.10% | 92.95% | 83.53% | 89.30% | 68.90% | 1.5943 | 88.91% |

In this example, power was evaluated to be 31.9%. The null hypothesis fails to be rejected based on the Z-statistic and confidence level. The segment is rolled up by one level and the difference in performance metrics is reevaluated for significance. The IROI is evaluated by Equation 4 only after the difference becomes significant.

### Example 2

Sample size significance observed and statistical difference observed.

| | | | | Segment i at | | Segment i at | | | |
|---|---|---|---|---|---|---|---|---|---|
| Segment i | | Segment i | | t_{ref} | | tₜₑₛₜ | | | |
| at t_{ref} | | at tₜₑₛₜ | | Upper | Lower | Upper | Lower | | Conf. |
| N | \hat{p} | N | \hat{p} | Limit | Limit | Limit | Limit | Z-Stat | Level |
| 715 | 94.75% | 272 | 88.00% | 96.38% | 93.12% | 91.86% | 84.14% | 3.1547 | 99.84% |

In this example, power was evaluated to be 91.3%. The null hypothesis is rejected based on the Z-statistic and confidence level. The IROI is evaluated by Equation 4.

### Example 3

Sample size significance not observed but statistical difference observed.

| | | | | Segment i at | | Segment i at | | | |
|---|---|---|---|---|---|---|---|---|---|
| Segment i | | Segment i | | t_{ref} | | tₜₑₛₜ | | | |
| at t_{ref} | | at tₜₑₛₜ | | Upper | Lower | Upper | Lower | | Conf. |
| N | \hat{p} | N | \hat{p} | Limit | Limit | Limit | Limit | Z-Stat | Level |
| 400 | 92.69% | 828 | 87.70% | 95.24% | 90.14% | 89.97% | 85.51% | 2.8612 | 99.58% |

In this example, power was evaluated to be 75.4%. The null hypothesis fails to be rejected based on the Z-statistic and confidence level. The segment is rolled up by one level and the difference in performance metrics is reevaluated for significance. The IROI is evaluated by Equation 4 only after the difference becomes significant.

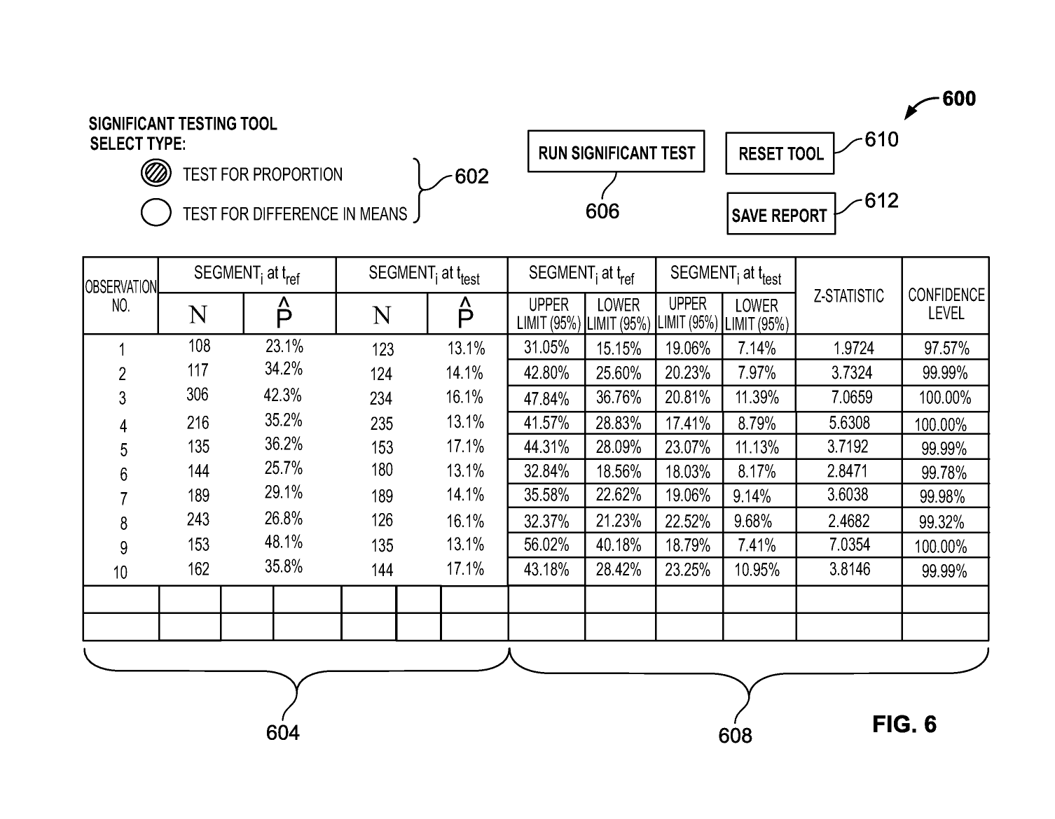

FIG. 6 shows illustrative tool 600 for testing significance. Interface control 602 may be provided to receive from an analyst a selection of a proportion test or a mean test. In this illustration, a proportion test was selected. Each observation represents a test of a proportion difference between a reference performance metric set and a test performance metric set for a given segment. Sample input data may be input, as illustrated, in region 604. Interface control 606 may be activated to calculate, for each observation, upper and lower limits for each of the reference and test performance metrics, a Z-score for the difference between the proportions, and a corresponding confidence level. In response to activation of interface control 606, the system may prompt the analyst for a selection of a 1- or a 2-tail test. The system may display output data in region 608.

Interface control 610 may be activated to reset the tool for receiving new input data. Interface control 612 may be used to save input data, output data or both as a report.

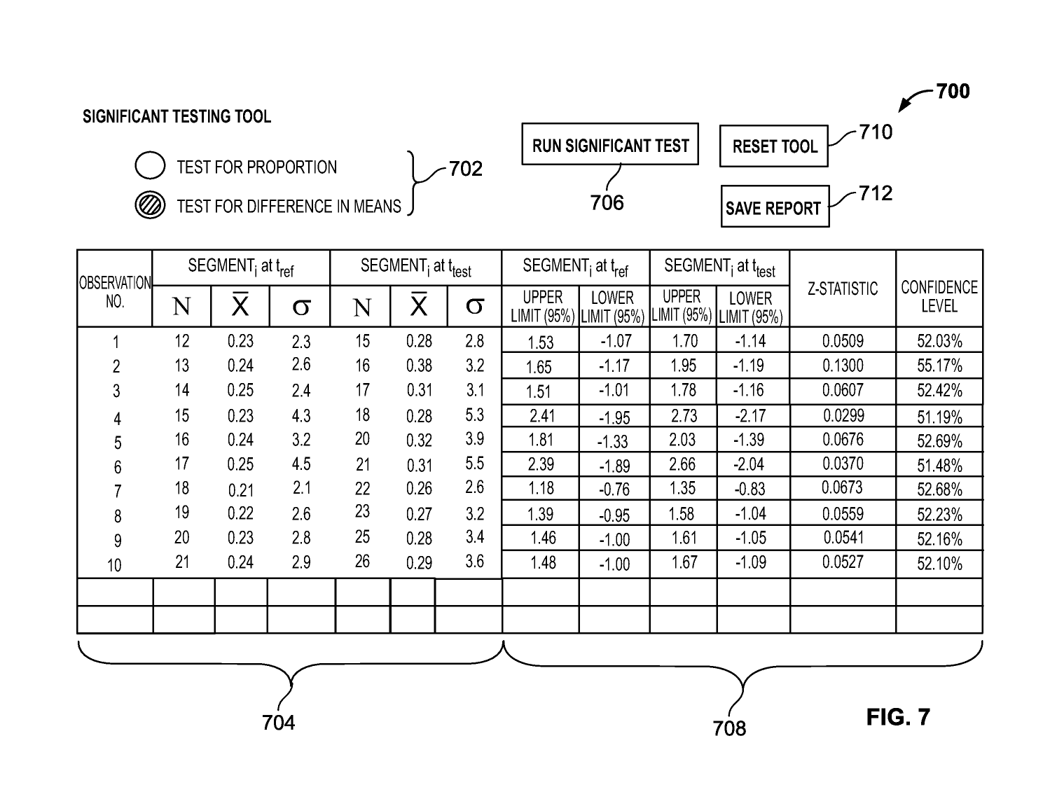

FIG. 7 shows illustrative tool 700 for testing significance. Interface control 702 may be provided to receive from an analyst a selection of a proportion test or a mean test. In this illustration, a means test was selected. Each observation represents a test of a means difference between a reference performance metric set and a test performance metric set for a given segment. Sample input data may be input, as illustrated, in region 704. Interface control 706 may be activated to calculate, for each observation, upper and lower limits for each of the reference and test performance metrics, a Z-score for the difference between the means, and a corresponding confidence level. In response to activation of interface control 706, the system may prompt the analyst for a selection of a 1- or a 2-tail test. The system may display output data in region 708.

Interface control 710 may be activated to reset the tool for receiving new input data. Interface control 712 may be used to save input data, output data or both as a report.

Thus, apparatus, methods, articles of manufacture including computer readable code, and media for making and using a product development tool have been provided. Persons skilled in the art will appreciate that the present invention can be practiced by other than the described embodiments, which are presented for purposes of illustration rather than of limitation. The present invention is limited only by the claims that follow.

What is claimed is:

1. Apparatus for development of a product, the apparatus comprising:
a processor configured to:
determine that a first set of performance metrics does not satisfy a threshold analysis criterion, the performance metrics corresponding to a deployed product and a first user segment; and
determine that a second set of performance metrics does satisfy the threshold analysis criterion, the second set of performance metrics corresponding to the deployed product and to a second user segment, the second user segment including the first user segment;
an input device configured to receive from a user:
a selection of a performance metric type; and
a selection of a process control flag;
machine-readable memory configured to store:
a first value of a first objective function corresponding to a first weight of the product;
a second value of a second objective function corresponding to a second weight of the product; and
a reference set of performance metrics corresponding to the product; and
an output device configured to indicate:
the second weight; and
that a score of the difference between the second set of performance metrics and the reference set of performance metrics exceeds a predetermined value.

2. The apparatus of claim 1 wherein the threshold analysis criterion is a power test criterion that is satisfied by inclusion in the second set of performance metrics a number of members.

3. The apparatus of claim 2 wherein:
the input device is further configured to receive a confidence level index that corresponds to the difference between the second set of performance characteristics and the reference set of characteristics; and
change a value of the power test criterion based on the confidence level index.

4. The apparatus of claim 3 wherein:
the input device is further configured to receive target change index that corresponds to the difference between the second set of performance characteristics and the reference set of characteristics; and
change a value of the power test criterion based on the target change index.

5. The apparatus of claim 1 wherein:
the machine readable memory is configured to store:
the first user segment;
the second user segment; and
the first and second user segments are included in a plurality of user segments, all but a one of the plurality of user segments being included in another of the user segments in the plurality.

6. The apparatus of claim 5 wherein:
the plurality of user segments is a first plurality; and the second user segment includes a second plurality of user segments, the second plurality including the first user segment; and
the processor is further configured to:
identify individual users corresponding to the second plurality of user segments; and
identify the individual users that belong to the second user segment.

7. The apparatus of claim 1 wherein the processor is configured to:
detect that the performance metric type is a proportion; and,
in response to detecting that the performance metric type is a proportion, compute a confidence interval for the second set of performance metrics.

8. The apparatus of claim 1 wherein the processor is configured to:
detect that the performance metric type is a proportion; and,
in response to detecting that the performance metric type is a proportion, compute a confidence interval for the second set of performance metrics.

9. The apparatus of claim 1 wherein:
the second set of performance metrics is represented by a second mean;
the reference set of performance metrics is represented by a reference mean; and
the difference includes a difference between the second mean and the reference mean.

10. The apparatus of claim 1 wherein the processor is further configured to calculate a confidence interval corresponding to the difference.

11. The apparatus of claim 1 wherein:
the second set of performance metrics is represented by a second proportion;
the reference set of performance metrics is represented by a reference proportion; and
the difference includes a difference between the second proportion and the reference proportion.

12. The apparatus of claim 1 wherein the processor is further configured to calculate a confidence interval corresponding to the difference.

13. The apparatus of claim 1 wherein the processor is further configured to evaluate the control flag as one of a one-tail test flag and a two-tail test flag.

14. The apparatus of claim 1 wherein the processor is configured to calculate, and the output device is configured to display, a product development score that includes:
if the score exceeds the predetermined value, the quantity:
$$\frac{\{ \begin{matrix}E ( second set of performance metrics ) - \\ E ( reference set of performance metrics )\end{matrix} \}}{E ( reference set of performance metrics )} ,$$
in which E means expected value; and,
if the score does not exceed the predetermined value, only the quantity zero.

15. The apparatus of claim 1 wherein the processor is configured to calculate, and the output device is configured to display, a product development score that includes:
if the score exceeds the predetermined value, the quantity:
$$\frac{{\hat{p}}_{second} - {\hat{p}}_{preference}}{{\hat{p}}_{preference}} ,$$
in which \hat{p} means average number of user successes for a respective set of performance metrics, the average number being the total number of successes divided by the total number of corresponding users; and,
if the score does not exceed the predetermined value, only the quantity zero.

16. The apparatus of claim 1 wherein the score is a z-statistic.

17. One or more non-transitory computer-readable media storing computer-executable instructions which, when executed by a processor on a computer system, perform a method for development of a product comprising:
determining that a first set of performance metrics does not satisfy a threshold analysis criterion, the performance metrics corresponding to a deployed product and a first user segment; and
determining that a second set of performance metrics does satisfy the threshold analysis criterion, the second set of performance metrics corresponding to the deployed product and to a second user segment, the second user segment including the first user segment;
receiving a selection of a performance metric type; and
receiving a selection of a process control flag;
storing a first value of a first objective function corresponding to a first weight of the product;
storing a second value of a second objective function corresponding to a second weight of the product; and
storing a reference set of performance metrics corresponding to the product; and
indicating the second weight; and
indicating that a score of the difference between the second set of performance metrics and the reference set of performance metrics exceeds a predetermined value.

18. The method of claim 17 wherein the threshold analysis criterion is a power test criterion that is satisfied by inclusion in the second set of performance metrics a number of members.

19. The method of claim 18 further comprising:
receiving a confidence level index that corresponds to the difference between the second set of performance characteristics and the reference set of characteristics; and
changing a value of the power test criterion based on the confidence level index.

20. The method of claim 19 further comprising:
receiving target change index that corresponds to the difference between the second set of performance characteristics and the reference set of characteristics; and
changing a value of the power test criterion based on the target change index.

21. The method of claim 17 further comprising:
storing the first user segment;
storing the second user segment; and
storing the first and second user segments are included in a plurality of user segments, all but a one of the plurality of user segments being included in another of the user segments in the plurality.

22. The method of claim 21 further comprising:
the plurality of user segments is a first plurality; and the second user segment includes a second plurality of user segments, the second plurality including the first user segment; and
identifying individual users corresponding to the second plurality of user segments; and
identifying the individual users that belong to the second user segment.

23. The method of claim 17 further comprising:
detecting that the performance metric type is a proportion; and,
in response to detecting that the performance metric type is a proportion, computing a confidence interval for the second set of performance metrics.

24. The method of claim 17 further comprising:
detecting that the performance metric type is a proportion; and,
in response to detecting that the performance metric type is a proportion, computing a confidence interval for the second set of performance metrics.

25. The method of claim 17 further comprising:
the second set of performance metrics is represented by a second mean;
the reference set of performance metrics is represented by a reference mean; and
the difference includes a difference between the second mean and the reference mean.

26. The method of claim 17 further comprising:
calculating a confidence interval corresponding to the difference.

27. The method of claim 17 further comprising:
the second set of performance metrics is represented by a second proportion;
the reference set of performance metrics is represented by a reference proportion; and
the difference includes a difference between the second proportion and the reference proportion.

28. The method of claim 17 further comprising:
calculating a confidence interval corresponding to the difference.

29. The method of claim 17 further comprising:
evaluating the control flag as one of a one-tail test flag and a two-tail test flag.

30. The apparatus of claim 17 further comprising:
calculating and displaying a product development score that includes:
if the score exceeds the predetermined value, the quantity:
$$\frac{\{ \begin{matrix}E ( second set of performance metrics ) - \\ E ( reference set of performance metrics )\end{matrix} \}}{E ( reference set of performance metrics )} ,$$
in which E means expected value; and,
if the score does not exceed the predetermined value, only the quantity zero.

31. The method of claim 17 further comprising:
calculating and displaying a product development score that includes:
if the score exceeds the predetermined value, the quantity:
$$\frac{{\hat{p}}_{second} - {\hat{p}}_{preference}}{{\hat{p}}_{preference}} ,$$
in which \hat{p} means average number of user successes for a respective set of performance metrics, the average number being the total number of successes divided by the total number of corresponding users; and,
if the score does not exceed the predetermined value, only the quantity zero.

32. The apparatus of claim 17 wherein the score is a z-statistic.
